(19) United States
(12) Patent Application Publication
(10) Pub. No.: US 2010/0002124 A1
(43) Pub. Date: Jan. 7, 2010

(54) IMAGE CAPTURING DEVICE WITH OPERATION SCHEDULING AND IMAGE CAPTURING METHOD THEREOF

(75) Inventor: CHANG-WEI CHENG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/331,438

(22) Filed: Dec. 10, 2008

(30) Foreign Application Priority Data
Jul. 4, 2008 (CN) 200810302533.X

(51) Int. Cl. H04N 5/225; H04N 5/222

(52) U.S. Cl. 348/333.02; 348/207.99; 348/E05.024

(57) ABSTRACT

An image capturing device includes a clock and an operation scheduling system. The operation scheduling system includes a selecting module, a setting module, a first storing module, a determining module, and an executing module. The selecting module is configured for selecting an operation from a plurality of different operations according to a user's selection. The setting module is configured for scheduling a time according to users input. The first storing module is capable of storing the operation selected and the schedule set by users. The determining module is configured for monitoring the clock and determining when it is time to perform a scheduled operation according to the schedule. The executing module is configured for executing the operation until the time of the clock arrive to the scheduled time.

### TECHNICAL FIELD

The present disclosure relates to image capturing devices and, particularly, to an image capturing device which can schedule operations and an image capturing method thereof.

### DESCRIPTION OF THE RELATED ART

With the development of optical imaging technology, image capturing devices, such as digital cameras or mobile phones, have been widely used. Most image capturing devices require a shutter button be used to capture an image. It is very inconvenient or difficult for the image capturing devices to be used in some special situations or fields, such as monitoring animals, monitoring suspects and so on, where scheduled image capturing may be more useful or necessary.

What is needed, therefore, is an image capturing device and an image capturing method to overcome the above problems.

### BRIEF DESCRIPTION OF THE DRAWINGS

Many aspects of the present image capturing device and method can be better understood with references to the accompanying drawings. The components in the drawings are not necessarily drawn to scale, the emphasis instead being placed upon clearly illustrating the principles of the present image capturing device and method.

FIG. 1 is a functional block diagram of an image capturing device, according to an exemplary embodiment.

FIG. 2 is a flow chart of an image capturing method according to an exemplary embodiment.

### DETAILED DESCRIPTION OF THE EMBODIMENTS

Embodiments of the present disclosure will now be described in detail below, with references to the accompanying drawings.

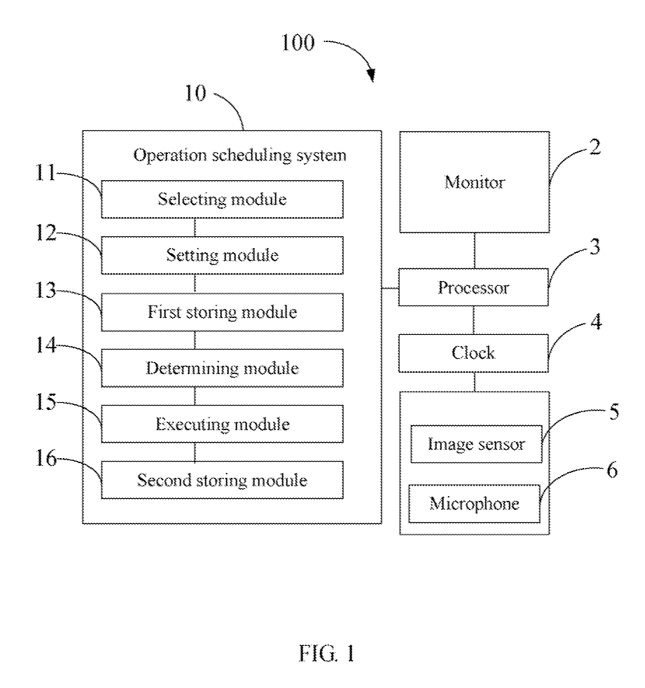

Referring to FIG. 1, an image capturing device 100, according to an exemplary embodiment, is shown. The image capturing device 100 includes a monitor 2, a processor 3, a clock 4, an image sensor 5, a microphone 6, and an operation scheduling system 10. The image sensor 5 is used for capturing photos or recording videos. The microphone 6 is used for recording audio.

The operation scheduling system 10 includes a selecting module 11, a setting module 12, a first storing module 13, a determining module 14, and an executing module 15.

The selecting module 11 is configured for selecting an operation from a number of different operations according to a user's selection. In the present embodiment, the different available operations are displayed on the monitor 2, allowing the user to conveniently select a desired operation. The operations may include still image capture, video capture, audio recording and so on. Still image capture may include more than one operation such as single image capture, capture of a specified number of images, or capturing images until available memory is filled. Video capture may also include more than one operation, such as capturing video for a specified amount of time or capturing video until memory is filled. Likewise, audio recording can include operations of recording audio for a specified amount of time or until memory is filled.

The setting module 12 is configured for scheduling a date and/or time. The scheduled time and date can be, for example, Oct. 5, 2008 5:30 AM. Users can input a schedule using a keyboard (not shown) of the image capturing device 100, and the monitor 2 can display the schedule input by the user. In the present embodiment, the monitor 2 has a touch panel, which can be used for inputting schedule and operation selections.

The first storing module 13 is configured for storing the operation selected and the schedule set by users.

The determining module 14 monitors the clock 4, which includes date and time, and determines when it is time to perform a scheduled operation according to the schedule stored in the first storing module 13. For example, if an operation has been scheduled to occur at 4 PM on Friday the 14^{th} of October, 2008, then the determining module 14 monitors the clock 4 until that time and date then sends an executing signal to the executing module 15.

The executing module 15 is configured for executing the operation stored in the first storing module 13 when receives the executing signal sent from the determining module 14. Photos, videos, or audios produced by corresponding operations can be stored in the first storing module 13 or a second storing module 16. In other words, in other alternative embodiments, the second storing module 16 can be omitted. In the present embodiment, the photos, videos, or audios produced by corresponding operations is stored in the second storing module 16. The second storing module 16 can be a removable memory, such as a SD card.

It should be mentioned that various components of the operation scheduling system 10 such as the selecting module 11, the setting module 12, the determining module 14, the executing module 15 can be individual electrical elements, or integrated into an additional central unit or the processor 3. Also, some components can be software modules written in a variety of computer languages such as C#, Visual C++, Visual Basic, C++, and so on, which can be executed by the processor 3.

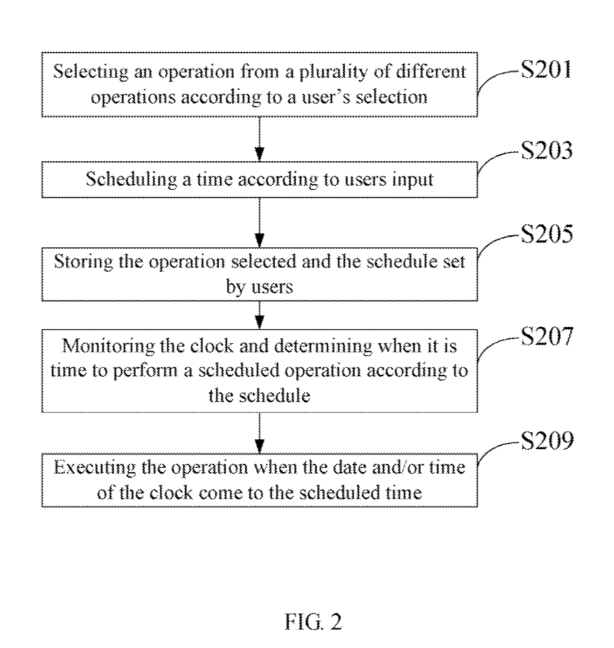

Referring to FIG. 2, an image capturing method of the image capturing device 100 is also provided. The steps of the method will be described as follows.

Step S201: selecting an operation from a number of different operations according to a user's selection. In the present embodiment, the selecting module 11 is configured for selecting an operation according to a user's selection. The operations may include still image capture, video capture, audio recording and so on.

Step S203: scheduling a date and/or time. The scheduled time and date can be, for example, Oct. 5, 2008 5:30 AM. Therefore, users need not to calculate the interval between current time and the scheduled time and date. In the present embodiment, the setting module 12 is configured for scheduling a date and/or time according to a user's inputting.

Step S205: storing the operation selected and the schedule set by users. In the present embodiment, the first storing module 13 is configured for storing the operation selected and the schedule set by users.

Step S207: monitoring the clock 4 and determining when it is time to perform a scheduled operation according to the schedule.

Step S209: executing the operation when the date and/or time of the clock 4 come to the scheduled date and/or time. In the present embodiment, if the time of the clock 4 come to the scheduled date and/or time, the determining module 14 will send out an executing signal to the executing module 15, and the executing module 15 will execute the operation stored in the first storing module 13 when received the executing signal.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. An image capturing device comprising:
a clock; and
an operation scheduling system, the operation scheduling system comprising:
a selecting module configured for selecting an operation from a plurality of different operations according to a user's selection;
a setting module configured for scheduling a time to perform the selected operation according to users input;
a first storing module capable of storing the selected operation and the schedule set the user;
a determining module configured for monitoring the clock and determining when it is time to perform a scheduled operation according to the schedule; and
an executing module configured for executing the operation according to the determination by the determining module.

2. The image capturing device as claimed in claim 1, further comprising a monitor capable of displaying the plurality of operations and the schedule input by the user.

3. The image capturing device as claimed in claim 1, wherein the plurality of different operations comprise still image capture, video capture, and audio recording.

4. The image capturing device as claimed in claim 3, wherein the still image capture comprises single image capture, capture of a specified number of images, and capturing images until available memory is filled.

5. The image capturing device as claimed in claim 3, wherein the video capture comprises capturing video for a specified amount of time, and capturing video until memory is filled.

6. The image capturing device as claimed in claim 3, wherein the audio recording comprises recording audio for a specified amount of time, and recording audio until memory is filled.

7. The image capturing device as claimed in claim 3, further comprising a second storing module for storing the photos, video, or audio produced by corresponding operations.

8. The image capturing device as claimed in claim 7, wherein the second storing module is a removable memory.

9. The image capturing device as claimed in claim 1, wherein the determining module sends out an executing signal to the executing module if the time of the clock comes to the scheduled time.

10. The image capturing device as claimed in claim 7, further comprising a microphone for audio operations.

11. An image capturing method of an image capturing device having a clock, the method comprising:
selecting an operation from a plurality of different operations according to a user's selection;
scheduling time for the selected operation according to users input;
storing the selected operation and the schedule set by users;
monitoring the clock and determining when it is time to perform the scheduled operation according to the schedule; and
executing the operation according to the determination.

12. The method as claimed in claim 11, wherein the plurality of different operations comprise still image capture, video capture, and audio recording.

13. The method as claimed in claim 12, wherein the still image capture comprises single image capture, capture of a specified number of images, and capturing images until available memory is filled.

14. The method as claimed in claim 12, wherein the video capture comprises capturing video for a specified amount of time, and capturing video until memory is filled.

15. The method as claimed in claim 12, wherein the audio recording comprises recording audio for a specified amount of time, and recording audio until memory is filled.
